(19) United States
(12) Patent Application Publication
(10) Pub. No.: US 2007/0108836 A1
(43) Pub. Date: May 17, 2007

(54) Electrohydraulic brake system for motor vehicles

(75) Inventor: Hans-Jorg Feigel, Rosbach (DE)

Correspondence Address: CONTINENTAL TEVES, INC., ONE CONTINENTAL DRIVE, AUBURN HILLLS, MI, 48326-1581, US

(73) Assignee: Continental Teves AG & Co. oHG

(21) Appl. No.: 10/567,300

(22) PCT Filed: Jul. 30, 2004
(86) PCT No.: PCT/EP04/51682

§ 371 Date: Jan. 4, 2007

(30) Foreign Application Priority Data
Aug. 6, 2003 (DE) 10335923.0

(51) Int. Cl. B60T 8/42

(52) U.S. Cl. 303/115.1; 303/10

(57) ABSTRACT

Disclosed is an electrohydraulic brake system for motor vehicles, which has a brake pressure sensor or main brake cylinder, a pressurizing medium reservoir, an electrohydraulic pressure source, separation valves, which are inserted in the connection between the main brake cylinder and the wheel brakes, inlet valves, which are connected before the wheel brakes, and outlet valves which are connected after the wheel brakes, as well as a valve block, which receives the pump, the separation valves as well as the inlet valves and the outlet valves, where the pressure source, the wheel brakes as well as the brake pressure sensor can be connected with the pressurizing medium reservoir. To produce a compact electrohydraulic equipment assembly, the brake pressure sensor (2) is integrated in such a manner in the valve block (16) that all the hydraulic connections between the brake pressure sensor (2) and the separation valves (27-30) as well as the inlet valves (47-50) are formed by bores in the valve block (16).

The invention relates to an electrohydraulic brake system for motor vehicles, with a brake pressure sensor, which can be actuated with a brake pedal, with a pressurizing medium reservoir, with at least one electrohydraulic pressure source, by means of which pressure can be applied to the wheel brakes of the motor vehicle, which brakes can be connected via at least one hydraulic connection, which can be sealed off by means of a separation valve, with a device for the identification of the driver's deceleration instruction, with inlet valves which are connected before the wheel brakes and outlet valves which are connected after the wheel brakes, with an electronic control and regulation unit, which, as a function of signals which are generated by the device for the detection of the driver's deceleration instruction, actuates the pressure source, the separation valve, of which there is at least one, as well as the inlet valves and the outlet valves, as well as with a valve block, which receives the separation valve, of which there is at least one, as well as the inlet valves and the outlet valves, where the pressure source, the wheel brakes as well as the brake pressure sensor can be connected with the pressurizing medium reservoir.

In known brake systems of this type, the brake pressure sensor is arranged on the vehicle's body or the so called dashboard of the vehicle, while the entire hydraulic valve-receiving valve block is arranged in an appropriate place in the motor space, so that hydraulic lines are required to connect these two components, which lines can be damaged or leak, and thus represent a potential source of failure.

Therefore, the problem of the present invention is to propose an electrohydraulic brake system of the type mentioned in the introduction, where the at least partial omission of the hydraulic lines results in an improved operational safety.

This problem is solved according to the invention by integrating the brake pressure sensor in the valve block in such manner that all of the hydraulic connections between the brake pressure sensor and the separation valve, of which there is at least one, as well as the inlet valves consist of bores in the valve block. This measure results in a compactly built construction group, which can be operated independently.

In an advantageous embodiment of the object of the invention, the electrohydraulic pressure source is consists of a pump, which is driven by an electromotor, and which is also integrated in the valve block in such a manner that the connections between the pump and the inlet valves consist of bores in the valve block. Alternatively, the electrohydraulic pressure source consists of a high-pressure reservoir, which is arranged on the valve block and which is charged by means of a motor-pump equipment assembly.

Another advantageous embodiment of the invention provides a pressurizing medium reservoir which is arranged on the valve block or which is formed in its entirety or partially by the valve block, and which provides hydraulic connections between the pressure source and the pressurizing medium reservoir as well as for hydraulic connections between the brake pressure sensor and the pressurizing medium reservoir, which connections consist of bores in the valve block.

Another advantageous embodiment of the object of the invention consists in that the electronic control and regulation unit is attached directly to the valve block, in such a manner that electrical, magnetic and thermal signal and power transmissions occur without the use of lines.

Here it is particularly advantageous if the hydraulic connection between the pressure source and the pressurizing medium reservoir, and optionally parts of the pressurizing medium reservoir, are heatable.

In another advantageous embodiment of the object of the invention, the valve block as well as a piston rod, which is used to actuate the brake pressure sensor, are connected in a manner which allows elastic oscillations to the body or to a dashboard of the motor vehicle or to a pedal system.

Another characteristic of the present invention consists in that the pressurizing medium reservoir presents a first chamber as well as a second chamber, where the aspiration side of the pump and, via the outlet valves, the wheel brakes are connected to the first chamber, while the brake pressure sensor is connected to the second chamber via a first, current-free closed (CC) valve which can be regulated by analog means. As a result of this measure, a comfortable pedal feeling is transferred to the driver in the “break-by-wire” operating mode, particularly in the pressure buildup phase. Here it is particularly advantageous to provide means for the detection of the pressurizing medium level in the first and the second chamber.

In order to transfer a comfortable pedal feeling to the driver in the “brake-by-wire” operating mode in the pressure decrease phase, the invention provides for the connection of the pressure of the brake pressure sensor to the input connection of the inlet valves via a second, current-free closed (CC) valve, which can be regulated by analog means.

Another advantageous embodiment of the object of the invention, the inlet valves and the outlet valve are designed as electromagnetically activated, current-free closed (CC) 2/2-way control valves.

Another advantageous embodiment of the invention assigns a separation valve to each wheel brake and it provides separations valves which are designed as electromagnetically activated, current-free open (CO) valves, which can be regulated by analog means.

The brake pressure sensor can be designed as a single-circuit main brake cylinder.

In another embodiment of the invention, the brake pressure sensor is assigned as a two-circuit main brake cylinder, whose secondary pressure space is connected via the first, current-free closed (CC) valve, which can be regulated by analog means, to the second chamber of the pressurizing medium reservoir, while the primary pressure space of said reservoir is connected via an electromagnetically activated 2/2-way control valve to the secondary pressure space.

In an additional advantageous variant of the object of the invention, the hydraulic pressure is connected before the piston of the main brake cylinder, where the pressure space receives pressure that is generated by the pump. By this measure, a simple hydraulic brake booster is produced.

It is advantageous here if, in the line which connects the pressure side of the pump to the pressure space, an electromagnetically activated, current-free open (CO) 2/2-way or control valve is inserted, which makes it possible to cut off the line. The hydraulic pressure space is advantageously connected with the insertion of a check valve to the pressurizing medium reservoir.

In addition, the piston delimits a trailing space, which is connected to the pressurizing medium reservoir, which in turn is connected via the check valve to the pressure space.

Another advantageous embodiment of the object of the invention provides an air regulator between the check valve and the pressurizing medium reservoir, and a parallel connection between the hydraulic series connection, which consists of the check valve and the air regulator, and an electromagnetically activated, current-free open (CO) control valve.

An increase in the pressure buildup dynamic, particularly in the “brake-by-wire” operating mode, is achieved by connecting the pressure sensor to the aspiration side of the pump and by arranging, between the connection of the pressure sensor and the pressurizing medium reservoir, a check valve which opens towards the pump.

In the context of the present invention, a method is also proposed for the operation of an electrohydraulic brake system for motor vehicles, which is equipped with a brake pressure sensor (main brake cylinder), which can be actuated by means of a brake pedal, with a pressurizing medium reservoir, with at least one electrohydraulic pressure source, whose pressure can be applied to the wheel brakes of the motor vehicle, which wheel brakes can be connected via at least one hydraulic connection, which can be sealed off by means of a separation valve, on the other hand to the brake pressure sensor (main brake cylinder), with a device for the identification of the driver's deceleration instruction, with inlet valves which are connected before the wheel brakes and outlet valves which are connected after the wheel brakes, with an electronic control and regulation unit, which, as a function of signals which are generated by the device for the detection of the driver's deceleration instruction, controls the pressure source which controls the separation valve, of which there is at least one, as well as the inlet valves and the outlet valves, as well as with a valve block, which receives the separation valve, of which there is at least one, as well as the inlet valves and the outlet valves, where the pressure source, the wheel brakes as well as the brake pressure sensor can be connected with the pressurizing medium reservoir. This method is characterized in that, in the normal brake operation, a continuous buildup of hydraulic pressure is produced in the wheel brakes by means of the electrohydraulic pressure source and a continuous decrease of the hydraulic pressure in the wheel brakes is produced by means of at least one separation valve.

The pressurizing medium volume which is displaced during the actuation of the brake pressure sensor, is led in a first phase via the separation valve to the wheel brakes and in a second phase via at least one electrically activated valve, which can be controlled by analog means, to the pressurizing medium reservoir.

The invention is explained in greater detail in the following description with reference to five embodiment examples in connection with the drawing in the appendix. In the drawing:

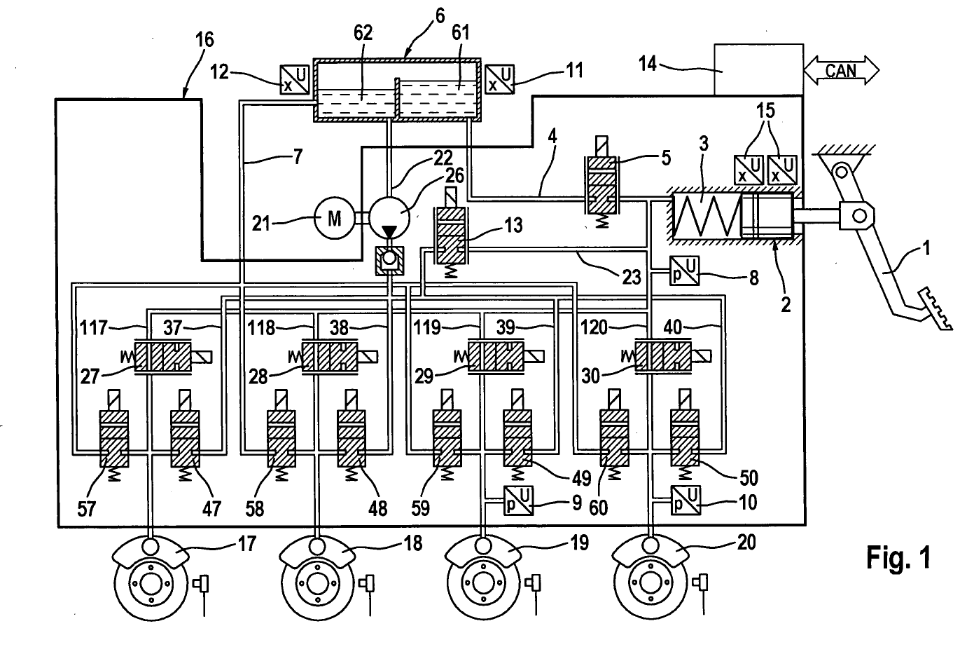

FIG. 1 shows a schematic representation of the first embodiment of the present invention,

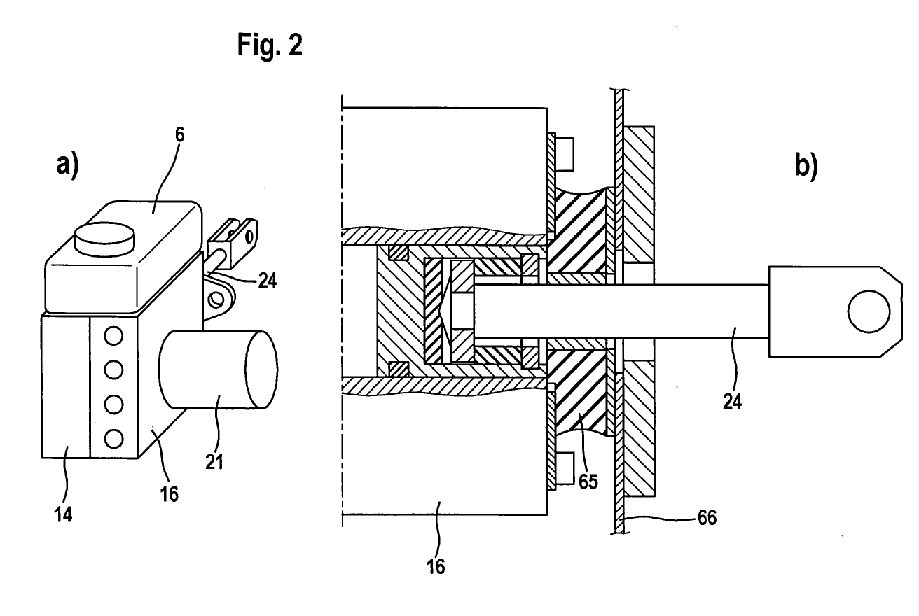

FIG. 2a, b shows a three dimensional representation of the hydraulic equipment assembly or its attachment in a motor vehicle, as shown in FIG. 1,

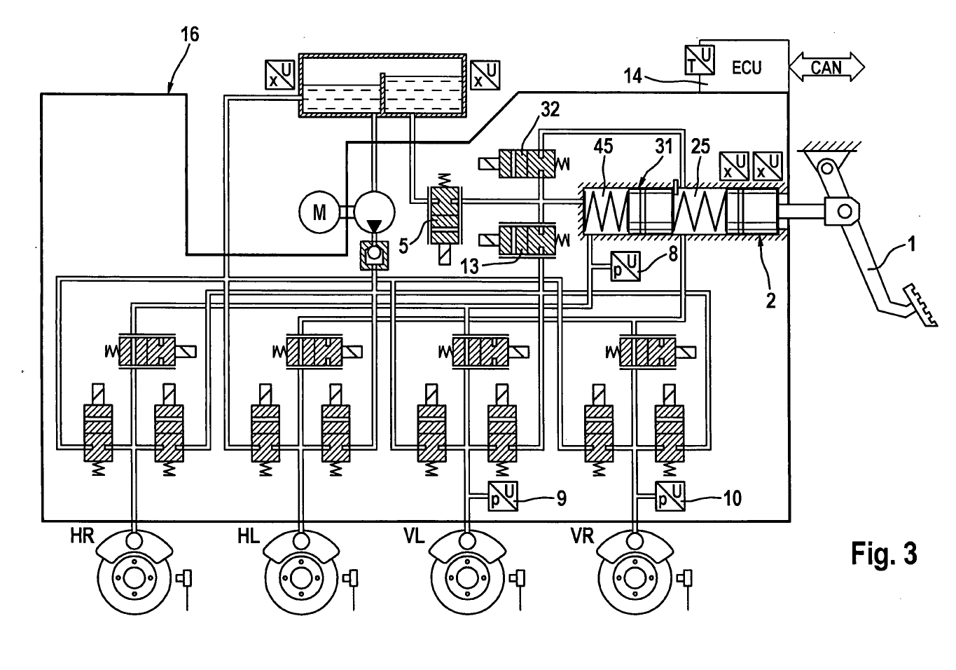

FIG. 3 shows a second embodiment of the present invention in a schematic representation, which corresponds to FIG. 1, and

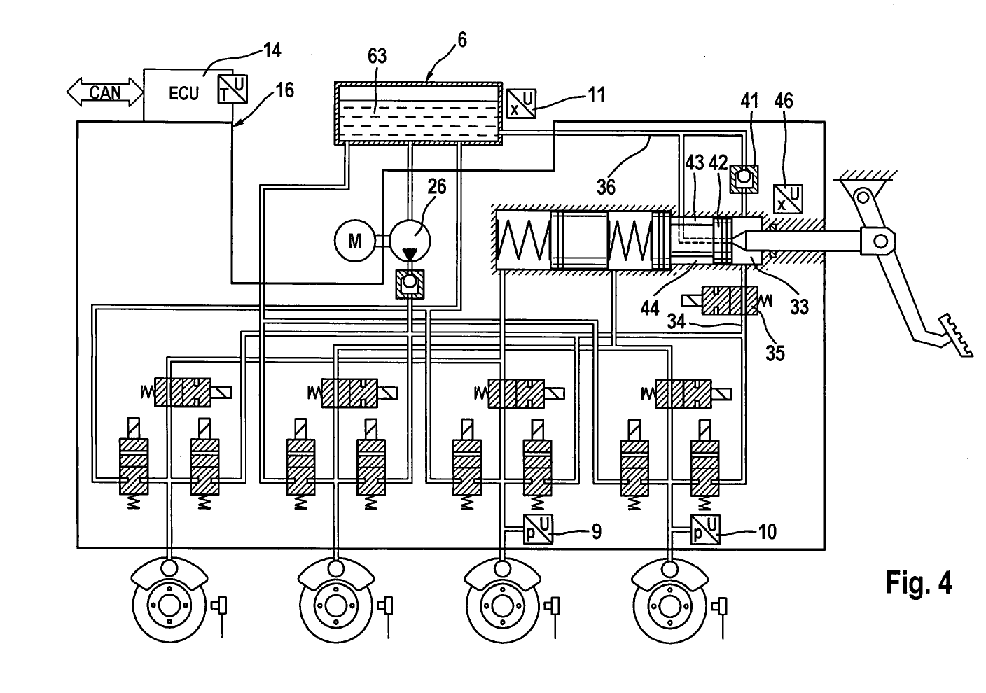

FIGS. 4, 5 and 6 show a third, a fourth and a fifth embodiment of the present invention in a schematic representation corresponding to FIG. 1.

The brake installation of the “brake-by-wire” type, which is shown only schematically in FIG. 1 of the drawing, presents a pressure sensor or main brake cylinder 2, which can be actuated by a an actuation pedal, which is identified with the reference numeral 1, where, in the examples shown, the main brake cylinder has a one-circuit design. In the single pressure space 3 of the main brake cylinder 2, the wheel brakes 17, 18, 19, 20 of a motor vehicle are connected via hydraulic lines, where separation valves 27, 28, 29, 30 are connected before said wheel brakes, and allow the cutting off of the hydraulic lines. The separation valves 27-30 are designed as electromagnetically controlled current-free closed (CC) 2/2-way valves, which can be regulated by analog means. A pressure sensor 8 allows the acquisition of the hydraulic pressure which is applied in a controlled manner in the pressure space 3. In addition, the pressure space 3 is in connection with a unpressurized pressurizing medium reservoir 6 via an additional hydraulic line 4, in which an additional, electromagnetically controlled, current-free closed (CC) 2/2-way valve 5, which can be regulated by analog means, is inserted. The pressurizing medium reservoir 6 presents two chambers 61, 62, where the pressure space 3 is connected to the first chamber 61, while the aspiration side of the hydraulic pump 26, which is driven by an electromotor 21 and forms an electrohydraulic pressure source, is connected to the second chamber 62. For the determination of the pressurizing medium level in the chambers 61, 62, measurement means 11, 12 are provided. On the pressure side of the pump 26, additional hydraulic lines 37, 38, 30, 40 are arranged, which lines are assigned to the wheel brakes 17-20, in which lines the inlet valves 47, 48, 49, 50, which are connected before the wheel brakes 17-20, are inserted, so that a pressure buildup can be produced in the wheel brakes 17, 18, 19, 20 by means of the hydraulic pump 26. In addition, the pressure side of the pump 26 is connected, via a second electromagnetically controlled, current-free closed (CC) 2/2-way valve 13, which can be regulated by analog means, to the above mentioned pressure space 3 of the main brake cylinder 2. For the decrease of the hydraulic pressure which is applied to the wheel brakes 17-20 during the operation, the outlet valves 57, 58, 59, 60 are used, whose output connections are connected to a line 7 which is connected to the second chamber 62 of the pressurizing medium reservoir. All inlet valves (47-50) and outlet valves 57-60 are designed as electromagnetically actuated, preferably current-free closed (CC) 2/2-way control valves. The pressure sensors 9, 10 are used to determine the hydraulic pressure which is applied to the wheel brakes 19, 20.

For the control of the electromotor 21 as well as of the above mentioned valves 5, 13, 27-30, 47-50, and 57-60, an electronic control and regulation unit 14, which is only indicated schematically, is used; this unit receives particularly the output signals of the pressure sensors 8, 9 and 10, the measurement means 11 and 12, and a preferably redundantly designed brake instruction detection device 15, which is associated with the main brake cylinder 2.

As indicated in FIG. 1, all the above mentioned valves 5, 13, 27-30, 47-50, and 57-60, the pump 26, as well as all the pressure sensors 8, 9, 10 are arranged in a metal valve block, which is provided with the reference numeral 16 and represented in FIG. 2. In addition, the valve block 16 receives the brake pressure sensor or the main brake cylinder 2, where all the hydraulic connections 117-120 between the main brake cylinder 2 and the separation valves 27-30, as well as all the hydraulic connections 37-40 between the name brake cylinder 2 or the pump 26 and the inlet valves 47-50 consist of bores in valve block 16. Other bores in the valve block 16 in addition form, at least partially, the sections of the connection 7, which contains the outlet valves 57-60, which connection is located between the wheel brakes 17-20 and the pressurizing medium reservoir 6 or 62, a connection 22 which follows after the aspiration side of the pump 26 on the pressurizing medium reservoir 6, the hydraulic connection 4, which leads from the main brake cylinder 2 or its pressure space 3 to the pressurizing medium reservoir 6, as well as the hydraulic connection 23 between the main brake cylinder 2 and the pressure side of the pump 26. The above mentioned pressurizing medium reservoir 6 is arranged here preferably on the valve block 16, or it is formed in its entirety or partially by the valve block. The electromotor 21 as well as the electronic control and regulation unit 14 are arranged in an opposite position, laterally on the valve block 16.

The compact construction unit, which is consists of the valve block 16, the pressurizing medium reservoir 6, the electromotor 21, and the electronic control and regulation unit 14, as well as a piston rod 24, which is used for the actuation of the brake pressure lever 2, are connected in a manner which allows elastic oscillations, for example by means of a rubber block 65, to the body or a dashboard 66 of the motor vehicle or a pedal system (see FIG. 2b).

In the second embodiment of the object of the invention, which is represented in FIG. 3, the brake pressure lever 2 is designed as a two-circuit main brake cylinder 31, where the above mentioned wheel brake 20, which is assigned, for example, to the right front wheel of the motor vehicle, as well as the above mentioned wheel brake 18, which is assigned, for example, to the left rear wheel of the motor vehicle, are attached on to said cylinder's first pressure space (primary pressure space) 25, while, the above mentioned wheel brake 19, which is assigned, for example, to the left front wheel of the motor vehicle, as well as the above mentioned wheel brake 17, which is assigned, for example, to the right rear wheel of the motor vehicle, are connected to the secondary pressure space 45. An additional difference compared to the first embodiment, which is shown in FIG. 1, consists in that the primary pressure space 25 is connected via an electromagnetically actuated 2/2-way control valve 32 to the secondary pressure space 45. Otherwise the construction of the brake system, which is represented in FIG. 3, corresponds to the construction of the embodiment according to FIG. 1.

In the third embodiment of the object according to the invention, which is represented in FIG. 4, and whose construction is very similar to the construction of the second embodiment according to FIG. 3, a hydraulic pressure space 33 is connected before the first piston 42 of the main brake cylinder 2, in an effective manner, where said pressure space receives the pressure which is generated by the pump 26. Here, in the line 34, which connects the pressure side of the pump 26 with a pressure space 33, an electromagnetically actuated, current-free open (CO) 2/2-way or control valve 35 is inserted, which makes it possible to cut off the line 34. Another line 36, with the insertion of a check valve 41 which opens towards the hydraulic pressure space 33, connects these pressure space 41 with the above mentioned pressurizing medium reservoir 6, which presents only a single chamber 63 in the depicted example. A trailing space 44, which is delimited by the piston 42 in the main brake cylinder, is also connected with the line 36. The driver instruction detection is carried out by a brake light switch 46, which is only indicated schematically. The described arrangement provides a simple hydraulic brake booster.

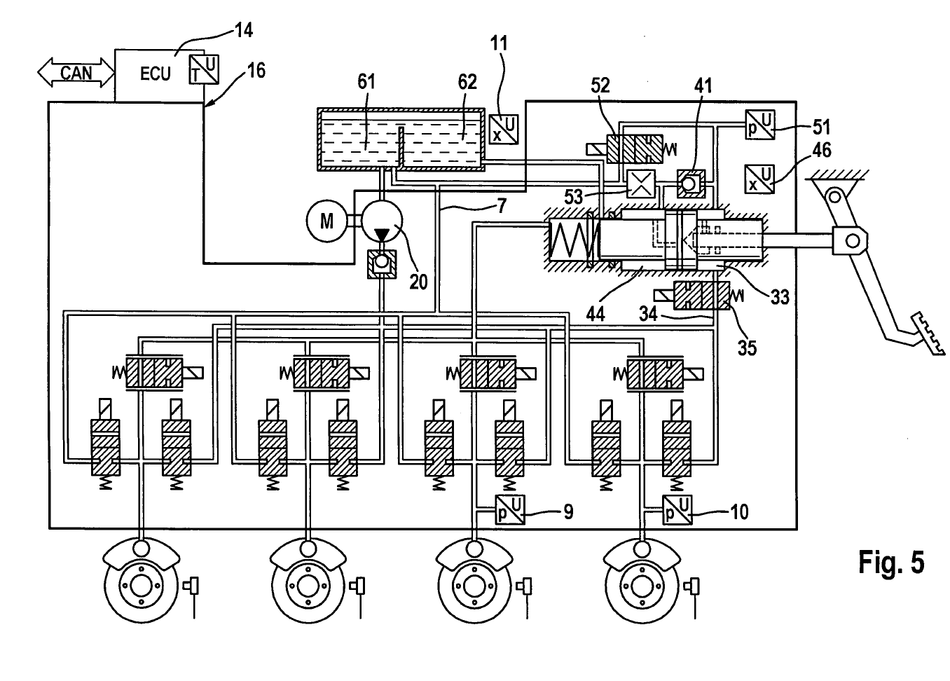

The fourth embodiment of the object according to the invention, which is represented in FIG. 5, and whose structure corresponds to the structure of the third embodiment according to FIG. 4, is also a hydraulic brake booster. In the arrangement shown, a pressure sensor 51 is connected to the hydraulic pressure space 33, where an air regulator 53 is connected after the check valve 41. An electromagnetically actuated, current-free open (CO) 2/2-way or control valve 52 is connected in parallel to the series connection of check valve 41-air regulator 53. The instruction arrangement allows a rapid filling of the pressure space 33 by the driver of the vehicle. The above mentioned pressure sensor 51 is used to regulate the wanted brake power assist.

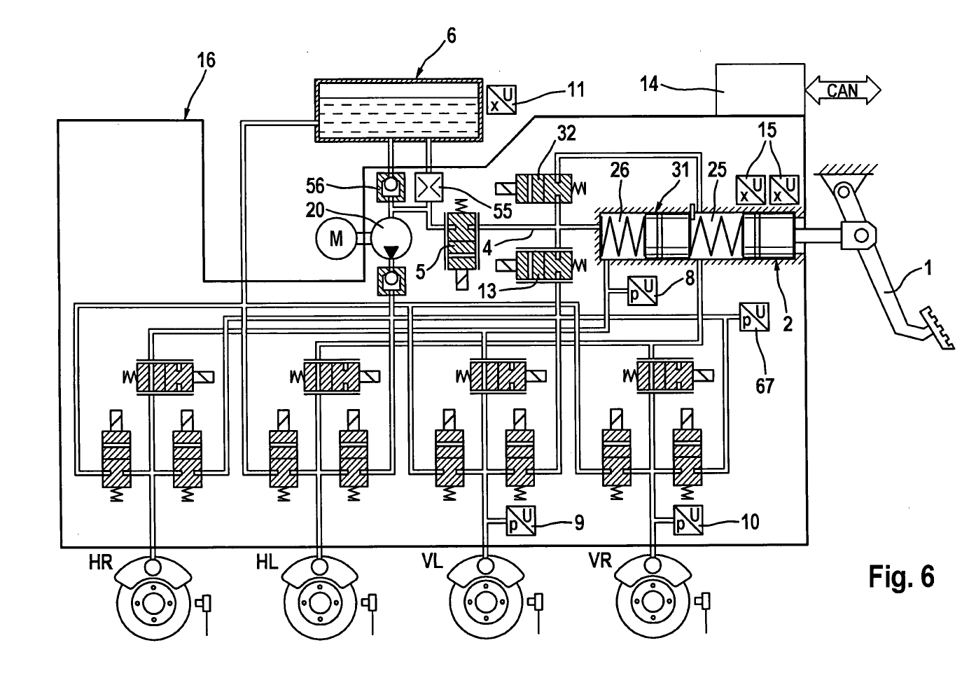

The fifth embodiment of the invention, which is shown in FIG. 6, in its structure corresponds to that of the second embodiment according to FIG. 3. However, in contrast to the second embodiment, an air regulator 55 is inserted between the electromagnetically actuated valve 5, which can be regulated by analog means and which was mentioned in connection with FIG. 3, and the pressurizing medium reservoir 6, where the line 4, which contains the valve 5, is connected to the aspiration side of the pump 26. In the line section between the connection of the line 4 and the pressurizing medium reservoir 6, a check valve 56 is connected, which opens toward the pump 26. For sensing the pressure generated by pump 26, a pressure sensor 67 is provided.

In the following description, the mode of operation of the electrohydraulic brake system according to the invention is explained. During the actuation of the brake pressure sensor 2 by the driver of the vehicle, a pressurizing medium volume is displaced through the open separation valves 27-30 into the four wheel brakes 17-19 (if desired either for the obtention of a rapid vehicle reaction, or only into the front wheel brakes), so that an application of the brake shoes as well as a first pressure buildup occur.

As a result of the detection of the actuation by means of the brake instruction detection device 15, which generates a corresponding signal for the electronic control and regulation unit 14, the pump 26 or its electromotor 21 are actuated. The intensity of the actuation is influenced by the speed of actuation. The pump 26, through the inlet valves 47-50, which have been switched to the open switch position, conveys the pressurizing medium into the wheel brake 17-20. As long as the pressure which is determined by the pressure sensor 8 is greater than the pressure which is measured at the wheel brakes 19, 20 by the pressure sensors 9, 10, a volume flow passes through the open separation valve into the wheel brakes. If the pressure which is applied by the pump 26 reaches the value which is determined by the pressure sensor 8, then the separation valves are closed and the additional pressure buildup is produced exclusively by means of the pump 26. The pulsation effect of the pump 26 on the pressure in the main brake cylinder 2 is very low and it is prevented at the instant when the separation valves 27-30 are closed.

Depending on the position of the main cylinder piston, its rate of position change and optionally other parameters, a wanted wheel brake pressure value as well as a wanted main cylinder pressure value are calculated in the electronic control and regulation unit 14 and they are included in the regulation of the inlet valves 47-50 or of the pump 26 by means of the actuation. The pressure decrease is then achieved by opening the separation valves 27-30 in connection with the actuation of the valve 5, which can be regulated by analog means. In case of a defect of the main brake cylinder 2, the pressure decrease occurs through the outlet valve 57-60.

In the case of a power failure, an unassisted pressure buildup occurs in all four wheel brakes 17-20, without any loss of path.

Using the brake system according to the invention, it is possible to carry out all of the operating functions of modem brake installations, such as, ABS, ESP, ASR, brake assist, springer function, as well as the required diagnostic functions, such as, for example, the determination of the correct function of the pressure sensor as well as the detection of leaks and air in the system. Naturally, within the scope of the invention, modifications are conceivable, such as, for example, the use of a high-pressure reservoir instead of the pump.

1-22. (canceled)

23. An electrohydraulic brake system for motor vehicles comprising:
a brake pressure sensor, which can be actuated by a brake pedal;
a pressurizing medium reservoir, having at least one electrohydraulic pressure source, by which pressure can be applied to wheel brakes of the motor vehicle, wherein the brakes can be connected via at least one hydraulic connection, which can be sealed off by a separation valve;
a device for identifying a deceleration instruction from a driver;
inlet valves which are connected before the wheel brakes and outlet valves which are connected after the wheel brakes;
an electronic control and regulation unit, which, as a function of signals which are generated by the device for the detection of deceleration instruction from a driver, actuates the pressure source, the separation valve, as well as the inlet valves and the outlet valves; and
a valve block, which receives the separation valve, as well as the inlet valves and the outlet valves, where the pressure source, the wheel brakes as well as the brake pressure sensor can be connected with the pressurizing medium reservoir, wherein the brake pressure sensor (2) is integrated in the valve block (16) in such a manner that all of the hydraulic connections between the brake pressure sensor (2) and the separation valve (27-30), of which there is at least one, as well as the inlet valves (47-50) are formed by bores in the valve block (16).

24. An electrohydraulic brake system according to claim 23, wherein the electrohydraulic pressure source consists of a pump (26) which is driven by an electromotor (21) and which is also integrated in the valve block (16) in such a manner that the connections between the pump (26) and the inlet valves (47-50) consist of bores in the valve block (16).

25. An electrohydraulic brake system according to claim 23, wherein the electrohydraulic pressure source consists of a high-pressure reservoir, which is loaded by means of a motor-pump aggregate.

26. An electrohydraulic brake system according to claim 23, wherein the pressurizing medium reservoir (6) is arranged on the valve block (16) and it is formed in its entirety or partially by the valve block (16), and in that the hydraulic connections between the pressure source (26) and the pressurizing medium reservoir (6), as well as between the hydraulic connections between the brake pressure sensor (2) and the pressurizing medium reservoir (6), consists of bores in the valve block (16).

27. An electrohydraulic brake system according to claim 23, wherein the electronic control and regulation unit (14) is attached directly to the valve block (16) in such a manner that electrical, magnetic and thermal signal and power transmissions occur without the use of lines.

28. An electrohydraulic brake system according to claim 27, wherein that the hydraulic connection (22) between the pressure source (26) and the pressurizing medium reservoir (6), and optionally parts of the pressure medium reservoir (6) can be heated.

29. An electrohydraulic brake system according to claim 23, wherein the valve block (16) and a piston rod (24), which is used to actuate the brake pressure sensor (2), are connected in a manner which allows elastic oscillations with the body or a dashboard (66) of the motor vehicle or to a pedal system.

30. An electrohydraulic brake system according to claim 23, wherein the pressurizing medium reservoir (6) presents a first chamber (61) as well as a second chamber (62), where the aspiration side of the pump (26) and, via the outlet valves (57-60), the wheel brakes (17-20) are connected to the first chamber (61), while the brake pressure sensor (2) is connected to the second chamber (62) via a first, current-free closed (CC) valve (5), which can be regulated by analog means.

31. An electrohydraulic brake system according to claim 31, wherein one or more devices (11, 12) are provided for detecting the pressurizing medium level in the first and the second chamber (61-62).

32. An electrohydraulic brake system according to claim 23, wherein the brake pressure sensor (2) is connected to the input connection of the inlet valves (47-50) via a second, current-free closed (CC) valve (13), which can be regulated by analog means.

33. An electrohydraulic brake system according to claim 23, wherein the inlet valves and the outlet valves (47-50, 57-60) are designed as electromagnetically activated, current-free closed (CC) 2/2-way control valves.

34. An electrohydraulic brake system according to claim 23, wherein the separation valves (27, 28, 29, 30) is assigned to each wheel brake (17, 18, 19, 20), and in that the separation valves (27-30) are designed as electromagnetically activated, current-free open (CO) valves, which can be regulated by analog means.

35. An electrohydraulic brake system according to claim 34, wherein the brake pressure sensor (2) is designed as a two-circuit main brake cylinder, whose secondary pressure space (45) is connected via the first, current-free closed (CC) valve (5), which can be regulated by analog means, to the second chamber (62), while the primary pressure space (25) of said cylinder is connected via an electromagnetically actuated 2/2-way control valve (32) to the secondary pressure space (45).

36. An electrohydraulic brake system according to claim 23, wherein the brake pressure sensor (2) is designed as a single-circuit main brake cylinder.

37. An electrohydraulic brake system according to claim 23, wherein a hydraulic pressure space (33) is connected before the piston (42) of the main brake cylinder (2), where the pressure space receives pressure that is generated by the pump (26).

38. An electrohydraulic brake system according to claim 37, wherein the line (34) which connects the pressure side of the pump (26) to the pressure space (33), an electromagnetically activated, current-free (CO) 2/2-way or control valve (35) is inserted, which makes it possible to cut off the line (34).

39. An electrohydraulic brake system according to claim 37, wherein the hydraulic pressure space (33) is connected with the insertion of a check valve (41) to the pressuring medium reservoir (6).

40. An electrohydraulic brake system according to claim 37, wherein the piston (42) delimits a trailing space (44), which is connected to the pressurizing medium reservoir (6), which in turn is connected via the check valve (41) to the pressure space (33).

41. An electrohydraulic brake system according to claim 37, wherein an air regulator (53) is provided between the check valve (41) and the pressurizing medium reservoir (6), and a parallel connection is provided between the hydraulic series connection, which consists of the check valve (41) and the air regulator (53), and an electromagnetically activated, current-free open (CO) control valve (52).

42. An electrohydraulic brake system according to claim 23, wherein the pressure sensor (2) is connected to the aspiration side of the pump (26) and, between the connection of the pressure sensor (2) and the pressurizing medium reservoir (6), a check valve (56) is arranged, which opens towards the pump (56).

43. A method for operating an electrohydraulic brake system for motor vehicles, with a brake pressure sensor, which can be actuated with a brake pedal, with a pressurizing medium reservoir, with at least one electrohydraulic pressure source, by means of which pressure can be applied to the wheel brakes of the motor vehicle, which brakes can be connected via at least one hydraulic connection, which can be sealed off by means of a separation valve, with a device for the identification of the driver's deceleration instruction, with inlet valves which are connected before the wheel brakes and outlet valves which are connected after the wheel brakes, with an electronic control and regulation unit, which, as a function of signals which are generated by the device for the detection of the driver's deceleration instruction, actuates the pressure source, the separation valve, of which there is at least one, as well as the inlet valves and the outlet valves, as well as with a valve block, which receives the separation valve, of which there is at least one, as well as the inlet valves and the outlet valves, where the pressure source, the wheel brakes as well as the brake pressure sensor can be connected with the pressurizing medium reservoir, the method comprising:
in a normal braking operation, producing a continuous buildup of hydraulic pressure in wheel brakes (17-20) by electrohydraulic pressure source (26); and
producing a continuous decrease of the hydraulic pressure in the wheel brakes (17- 20) by at least one separation valve (27-30).

44. A method according to claim 43, wherein during the actuation of the brake pressure sensor (2), the displaced pressurizing medium volume is led, in a first phase, via the separation valves (27-30), to the wheel brakes (17-20) and, in a second phase, via at least one electrically actuated valve (5), which can be controlled by analog means, to the pressurizing medium reservoir (6).
